(19) United States
(12) Patent Application Publication
(10) Pub. No.: US 2024/0181983 A1
(43) Pub. Date: Jun. 6, 2024

(54) DEVICE FOR PROVIDING ONE OR MORE FUNCTIONAL VOLTAGES IN A VEHICLE ELECTRICAL SYSTEM

(71) Applicant: LISA DRÄXLMAIER GMBH, Vilsbiburg (DE)

(72) Inventor: Michael WORTBERG, Dorfen (DE)

(73) Assignee: LISA DRÄXLMAIER GMBH, Vilsbiburg (DE)

(21) Appl. No.: 18/526,750

(22) Filed: Dec. 1, 2023

(30) Foreign Application Priority Data
Dec. 2, 2022 (DE) 10 2022 131 938.5

(51) Int. Cl. B60R 16/03; H02H 9/02

(52) U.S. Cl. CPC B60R 16/03; H02H 9/02

(57) ABSTRACT

A device for providing one or more functional voltages in a vehicle electrical system for the supply of electrical components. The device includes: a device input, on which a battery voltage can be applied, and a plurality of device outputs, to which the electrical components can be connected; a plurality of voltage converters with respective inputs, which are connected to the device input, and respective outputs. Each voltage converter is configured to provide an output voltage at its output based on a voltage applied to the respective input and an adjustable duty cycle. The device includes a control unit that is configured to regulate the duty cycle of the respective voltage converter, in which the outputs of the voltage converter are connected to the device outputs according to a connection matrix to provide a current-carrying capacity of the device outputs adapted to the respective connected component.

### CROSS-REFERENCE TO RELATED APPLICATIONS

This application claims priority to and the benefit of German Application No. 10 2022 131 938.5, filed on Dec. 2, 2022. The disclosure of the above application is incorporated herein by reference.

### FIELD

The present disclosure relates to a device for providing of one or more functional voltages for the supply of electrical components in a vehicle electrical system.

### BACKGROUND

The statements in this section merely provide background information related to the present disclosure and may not constitute prior art.

Today's electrical power systems are based on 12V voltage levels. Some functions, such as, for example, roll stabilization, are supplied in 48V island electrical systems. In general, raising the x-by-wire control to the 48V voltage level would increase the available power dynamics. Previous concepts with 48V voltage level have a central, large 48V/12V converter. There are thus two main distributions in conventional two-voltage LV (low voltage) electrical systems. The first main distribution in the 48V electrical system for the 48V electrical system participants, and the second in the 12V electrical system for the 12V electrical system participants.

### SUMMARY

This section provides a general summary of the disclosure and is not a comprehensive disclosure of its full scope or all of its features.

The present disclosure provides an advantageous concept for a simpler and more flexible voltage distribution in the electrical system.

The present disclosure is based on the idea of realizing only one 48V main distribution in the electrical system, instead of the two customary main distributions up to now in conventional two-voltage low-voltage electrical systems, namely for the 48V distribution and the 12V distribution. The 48V main distribution can have significantly reduced cross-sections in comparison to a 12V distribution. The 48V participants are directly connected to the 48V main distribution. For the 12V participants, the 12V is provided decentralized via compact 48V/12V converters.

The special nature of the converters is that the converters simultaneously act as e-fuses (electronic fuses) for the 12V channels, i.e. as so-called “e-fuse converters.” The e-fuse converter contains a plurality of small DC/DC downward converters connected in parallel, which are designated as “phases” below. The e-fuse converter can be configured by a flexible phase interconnection via a connecting matrix for load-specific currents of the load channels. By way of example, the manifestation of the e-fuse converter as a multiphase converter with 14 phases, each with 3A current-carrying capacity is depicted. In one configuration, all fourteen 3A phases can be interconnected to one output channel to provide up to 42A for one load. In another example, five of the 3A phases can be interconnected for a 15A channel, and nine of the 3A phases can be interconnected into a 27A channel. The phases can provide function voltages on the load side, for example, functional voltages of 5V, 3.3V, 6V, 7V, etc. These voltages therefore need not be generated in the consumers themselves, for example, by conversion from 12V to 5V. Since there is no battery on the consumer side, there is no fixing on a battery voltage of, for example, 12V.

The multiphase converter can also provide 0V for a phase. A motor that is connected to two phases can therefore be controlled in its direction of rotation directly via the converter. A subsequent full-bridge circuit for the direction of rotation control can be omitted.

The present disclosure is based on a channel-configurable multiphase converter with electronic fuses. Here, conversion and overcurrent protection for the load and the line to the load are carried out in one step. The converter has multiphases with generic channel currents, e.g., 3A, that can be connected in parallel to achieve higher currents. These can be defined via hardware configuration. The phase voltages can be configured via software, for example, by pulse width modulation (PWM) with duty cycle on the longitudinal transistor of the multiphase converter, for example, from 48V down to 3.3V. A 0V voltage can also be set, for example, to provide a bridge control for changing the direction of DC motors. A consumer with functional safety requirements can be supplied by n+1 phases. For example, a 9A consumer by 3*3A+3A, i.e., in total 4 phases. For the fail operational safety requirement of the supply of the FUSI (functional safety) consumer, one phase can therefore fail. The safety objective “provide supply” is thus derived from a technical safety concept of the fail silent phases and the detection of the failure of a phase. The maximum current of a converter phase is limited. Thus, the short-circuit current is also limited, and consequently also the potential feedback in the electrical system.

With the inventive solution, the following technical advantages can be realized: cross-section reduction of the lines, and thus associated weight reduction and raw material preserving production. The electrical losses are significantly reduced. Higher power dynamics can be achieved, for example, for participants such as EPS and suspension functions. With the inventive solution, new concepts for safe energy supply can be provided. The e-fuse converters presented here can replace conventional and electronic power distributors.

According to a first aspect, the present disclosure provides a device for the provision of one or more functional voltages in a vehicle electrical system for the supply of electrical components. The device comprises the following: a device input to which a battery voltage can be applied, and a plurality of device outputs, to which the electrical components can be connected; a plurality of voltage converters, each with inputs that are connected to the device input, and each with outputs; each voltage converter being configured to provide an output voltage at its output, based on a voltage applied to the respective input and an adjustable duty cycle; and a control unit that is configured to regulate the duty cycle of the respective voltage converter, in which the outputs of the voltage converter are connected to the device outputs according to a connection matrix to provide a current-carrying capacity of the device outputs adapted to the respective connected component.

The device provides a simple and flexible voltage distribution in the electrical system, in which the multiple distributions of different low voltages via dedicated lines and power distributors can be omitted.

The device provides a configurable parallel connection of voltage converters. Due to the parallel connection, the current-carrying capacity of the device outputs is adjustable. The voltage values of voltage converters connected to one another in parallel are all regulated the same way.

The individual outputs of the voltage converters are combined in groups via the connection matrix, which are each interconnected, i.e., connected in parallel to provide the corresponding current. Due to the grouping, it is possible to provide different channel current carrying capacities to the interconnected channel outputs of the voltage converters.

According to the prior art, all loads, such as for example, control devices in the 12V electrical system are supplied with 12V. In the control devices there are respective additional DC/DC converters, which provide, for example, 5V for the supply of microprocessors converted from the 12V. In contrast, the device directly provides the configurable functional voltages, such as, for example 5V so that with the use of such a device in the electrical system with a 48V battery voltage, the second battery with a 12V voltage level, the electronic 12V distribution/protection with e-fuses, and the conversion to the functional voltage in the load can be omitted.

The respective outputs of the voltage converter, which are connected to a corresponding device output via the connection matrix, thus define corresponding phase-parallel circuits. Each of the phase-parallel circuits specifies a channel of the device, wherein the number of channels corresponds to a number of the device outputs of the device.

According to one form of the device, for each phase-parallel circuit the control unit is configured to determine a load current at the channel output or the device output. In the event of exceeding a threshold value of the output value, to limit the load current to the threshold value and to disconnect the channel after a configurable time with overload current limitation via the channel-associated phases.

Thus, the device simultaneously acts as an e-fuse, i.e., electronic fuse, so that an external or additional implementation of an e-fuse can be omitted.

According to one form of the device, the control unit is configured to determine a load current for each device output, and in the event of exceeding a threshold value of the load current, to limit the load current to the threshold value. If the current limitation remains at the threshold value for a configurable time, e.g., 100 ms, the channel is then switched off due to overload or short circuit.

Thus, the device simultaneously acts as an e-fuse. An external or additional implementation of an e-fuse can be omitted.

According to one form of the device, the connection matrix is specified by a hardware configuration, or configurable via additional switching elements and software.

Thus the device can be configured in a customer-specific manner. For example, the connection matrix in the circuit board assembly can be implemented in a customer-specific or product-specific manner, for example, by soldering with the pin-in-paste method. Alternatively or additionally, the device can be configured via software.

In addition, there is the possibility to change the connection matrix dynamically. For example, a dynamic interconnection can be realized via switches, for example, to thereby retrofit or replace components.

According to one form of the device, the connection matrix respectively connects one part of the outputs of the voltage converters or phases to a respective device output, on which a respective functional voltage is provided.

Thus, with the device a plurality of electrical consumers can be supplied with their configured functional voltages that can be different for each consumer, e.g., 12V for an actuator and 3.3V or 5V for another load.

According to one form of the device, a current-carrying capacity of the respective device output is increased according to the number of outputs or phases of the voltage converters, and which outputs or phases are connected to the device output. Thus, even consumers that draw high currents can be connected to the device.

According to one form of the device, according to the connection matrix, a number of N+1 outputs or phases of the voltage converter are connected to a corresponding device output to provide a current-carrying capacity of a number of N connected outputs or phases in the event of failure of one of the voltage converters.

Thus in the event of failure of a voltage converter, the entire supply of an electrical component does not fail immediately, but rather a redundant supply is made possible.

According to one form of the device, the functional voltages and/or the output voltages of the voltage converters can be configured by software individually for each voltage converter, or for individual groups of voltage converters.

Thus, the functional voltages that are provided by the device can be easily reconfigured by software, so that hardware changes or replacement of the entire device is avoided.

According to one form of the device, the respective voltage converters or phases are configured as downward converters, and comprise the following: a first switching element and a coil that are connected in series between the input and the output of the respective voltage converter; a second switching element that is connected between a node that connects the first switching element to the coil in series, and a ground connection; and a capacitor that is connected between the output of the respective voltage converter and the ground connection. Thus, the individual voltage converters can easily be implemented since they are based on proven circuits.

According to one form of the device, the control unit is configured to set the duty cycle of the respective voltage converter on the basis of the output voltage at the output of the respective voltage converter and a voltage at the second switching element.

Thus, these voltages can easily be measured, and the control unit can adjust the corresponding voltage converters with low latency.

According to one form of the device, the control unit is configured to determine an output voltage of the respective voltage converter based on the duty cycle, the output voltage, and the voltage at the second switching element of the respective voltage converter. The control unit is configured to control the first switching element to carry out an electronic separation of the corresponding voltage converter from the battery voltage in case of exceeding a threshold value of the output current of one of the voltage converters.

Thus, the device simultaneously implements an e-fuse, i.e., electronic fuse, so that an external e-fuse or conventional fuse can be omitted.

According to one form of the device, the first switching element is configured as a series circuit made of a first transistor and a redundant first transistor; and the second switching element is configured as a series circuit made of a second transistor and a redundant second transistor.

Thus, the redundant transistor can take over the switching function when the first transistor fails. Due to the redundant components, the device thus offers an increased security against failure of the components.

According to one form of the device, a first measuring point is formed between a first node that connects the first transistor to the redundant first transistor in series; and a second measuring point is formed between a second node that connects the second transistor to the redundant second transistor in series, and the control unit is configured to detect an operability of the first transistor and of the second transistor based on recording the voltages at the first measuring point and at the second measuring point. Thus, the device can efficiently verify whether the switching elements or the transistors are working properly.

According to one form of the device, the first measuring point is connected to ground with a pull-down resistor with a parallel capacitor; and the second measuring point is connected to ground with a further pull-down resistor with parallel capacitor. Using such pull-down resistors, a defined voltage can be set at the measuring point when both transistors are switched off (high-impedance).

According to one form of the device, with a first recognized functional capacity of the first transistor and of the second transistor, the control unit is configured to switch the first transistor and the second transistor to powered, and to switch the redundant first transistor and the redundant second transistor to unpowered. Thus, a fail silent design or a fail silent safety concept can be realized.

According to one form of the device, in the event of a fault of the first transistor the control unit is configured to switch the redundant first transistor to powered, and in the event of a fault of the second transistor to switch the redundant second transistor to powered. Thus, a rapid switchover to the redundant components is possible when a fault occurs. Over voltages do not occur at the output when the first transistor fails in a low-resistance manner. With a high-resistance failure of the transistor, the phase is switched off.

According to one form of the device, the device is configured to provide a first functional voltage for a first connection of an electric motor, and a second functional voltage for a second connection of the electric motor. Thus, a simple control for an electric motor or DC motor can be realized.

According to one form of the device, the device is configured to provide one of the first and of the second functional voltages as zero volts to set a direction of rotation of the electric motor. Thus, both a clockwise rotation and a counterclockwise rotation of the electric motor or DC motor can be realized.

According to a second aspect, the present disclosure provides a method for the provision of one or more functional voltages in a vehicle electrical system for the supply of electrical components. The method comprises: connecting the device input of the device according to the first aspect to a battery voltage; and providing the functional voltages on the device outputs of the device, where the number of outputs connected via the connection matrix determines the available current, and the PWM regulated by the control unit sets the level of the functional voltage.

The method facilitates a simple and flexible multi-voltage distribution in the electrical system, in which dedicated distribution networks with battery for each low voltage can be omitted. With the method, the functional voltages can be provided directly and adapted to the load, so that when using the method in the electrical system with a 48V battery voltage, the second 12V battery, the electronic 12V distribution/protection with e-fuses, and the conversion to the functional voltage in the load can be omitted.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows a block circuit diagram of the conventional 2-voltage low-voltage electrical system 100 according to the present disclosure;

FIG. 2 shows a block circuit diagram of an electrical system 200 with a multiphase converter, here also called MCD, according to the present disclosure;

FIG. 3 shows a circuit diagram of an device 300 for the provision of functional voltages in an electrical system according to one form of the present disclosure;

FIG. 4 shows a circuit diagram of a device 300 for the provision of functional voltages in an electrical system according to a furtherform of the present disclosure;

FIG. 5 shows a circuit diagram of a device 300 for the provision of functional voltages in an electrical system with connected electrical components according to a form of the present disclosure;

FIG. 6 shows a circuit diagram of a basic circuit of a multiphase converter 600 according to a form of the present disclosure;

FIG. 7 shows a circuit diagram of an individual phase 700 of the multiphase converter 600 with control unit that is provided for each phase according to a form of the present disclosure;

FIG. 8 shows a circuit diagram of an individual phase 800 of the multiphase converter 600 with control unit for the fail silent design of one of the phases of the multiphase converter according to a form of the present disclosure; and

FIG. 9 shows a schematic diagram that shows the control of the transistors of the individual phases 800 of the multiphase converter 600 according to a form of the present disclosure.

The Figures are only schematic depictions and serve only for the explanation of the present disclosure. Identical or identically functioning elements are consistently provided with the same reference numerals.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the following detailed description, reference is made to the accompanying drawings that form a part thereof and in which specific forms are shown as illustration. Other forms can also be used, and structural or logical changes can be made without deviating from the concept of the present disclosure. The following detailed description is therefore not to be understood in a limiting sense. The features of the various forms described herein can be combined with one another unless specifically indicated otherwise.

The aspects and forms are described with reference to the drawings, wherein identical reference numerals relate in general to the same elements. In the following description, numerous specific details are presented for explanatory purposes to convey a detailed understanding of one or more aspects of the present disclosure. However, for a person skilled in the art it can be obvious that one or more aspects or forms can be incorporated having a lower degree of the specific details. In other cases, known structures and elements are depicted in schematic form to facilitate the description of one or more aspects or forms. Other forms can be used, and structural or logical changes can be made without deviating from the concept of the present disclosure.

In the present disclosure, criteria and requirements for functional safety (FUSI) in vehicles are described. Functional safety refers to the part of the safety of a system that depends on the correct function of the safety-related system and other risk-mitigating measures. In the automotive field, functional safety is usually described in the form of ASIL (automotive safety integrity level) classes. The ASIL classification is composed of various factors; these are 1) severity—S corresponding to the severity of the fault, the danger to the user or to the environment; 2) exposure—E corresponding to the probability of occurrence, i.e., frequency and/or duration of the operating state: 3) controllability—C corresponding to the controllability of the fault. Four different ASIL levels arise from these factors: ASIL A: recommended probability of failure less than 10⁻⁶/hour; ASIL B: recommended probability of failure less than 10⁻⁷/hour; ASIL C: required probability of failure less than 10⁻⁷/hour; ASIL D: required probability of failure less than 10⁻⁶/hour.

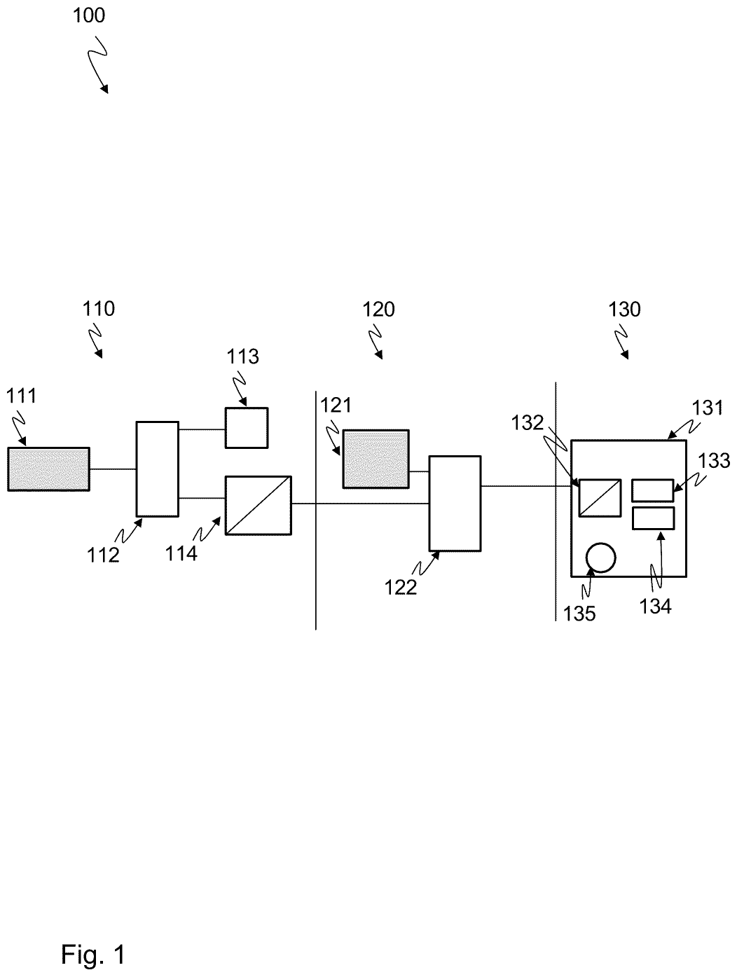

FIG. 1 shows a block circuit diagram of the conventional 2-voltage low-voltage electrical system 100. The 2-voltage low-voltage electrical system 100 comprises a 48V electrical system 110 and a 12V electrical system 120.

There are high-power consumers 113 that are supplied from the 48V electrical system, and consumers 131 that are supplied from the 12V electrical system 120. For the two voltage levels there is a battery 111, 121. The functional voltage for the circuits in a load (e.g., 5V) is generated in the loads 131; see 12V/5V converter 132. For reasons of freedom from feedback for the safe energy supply in the 12V electrical system, the 12V distribution must be carried out with expensive, fast semiconductor switches (e-fuses). Here “freedom from feedback” means that an undervoltage due to short circuit does not further propagate a load as undervoltage to a neighboring load relevant to FUSI (functional safety).

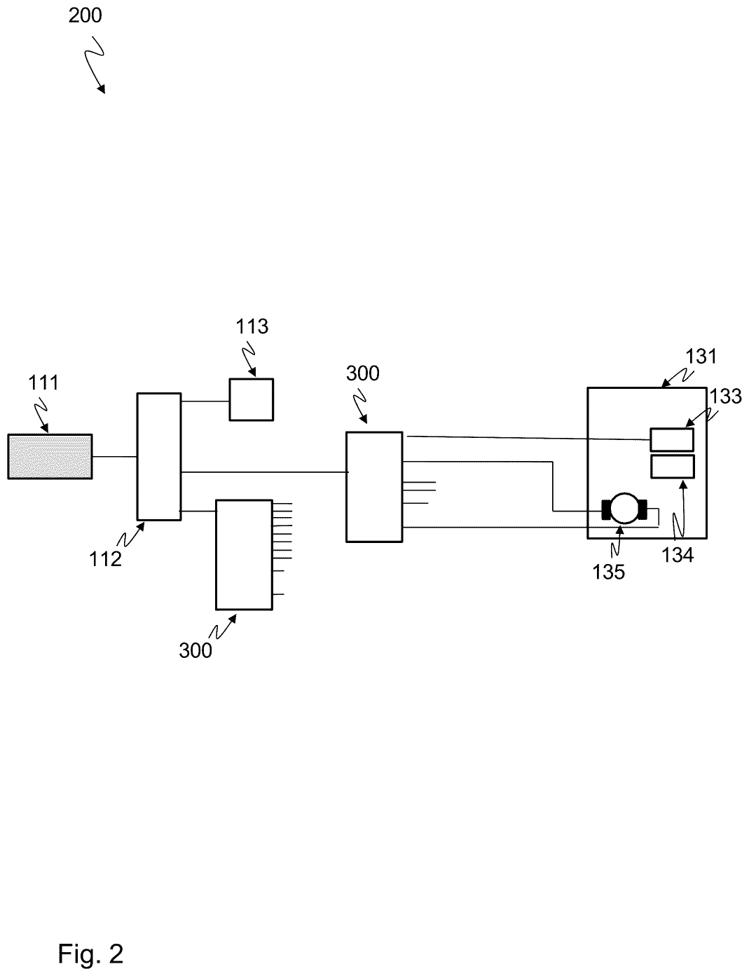

FIG. 2 shows a block circuit diagram of an electrical system 200 with an multiphase converter 300, here also called MCD. The multiphase converter 300 corresponds to the device 300 described in the present disclosure for the provision of one or more functional voltages.

The configurable multiphase converter 300 provides electronically fused outputs and is thus synergistically also an electronic distributer. Since the MCD converter 300 provides the functional voltage of the load directly, the 12V battery 121, the electronic 12V distribution/protection 122 with e-fuses, and the conversion 132 for the functional voltage in the load 131, as shown in FIG. 1, can be omitted.

The mode of operation of the multi-phase converter 300 or of the device 300 for the provision of one or more functional voltages is described in more detail in the following sections.

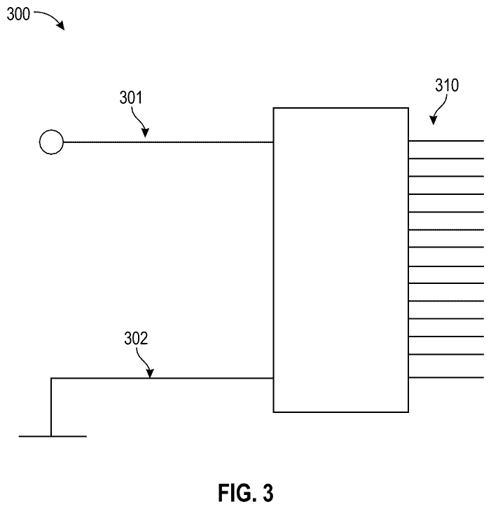

FIG. 3 shows a circuit diagram of a device 300 for the provision of functional voltages in an electrical system according to a form.

The device 300 constitutes a DC/DC converter for the decentralized supply of the low-voltage electrical system, with, for example, 12V (optionally 5V), starting from a 48V backbone as one example. The converter provides electronically fused outputs 310, and is thus synergistically also an electronic distributer.

In the form in FIG. 3, an e-fuse converter with 14 outputs 310, each with 3A load-carrying capacity, and each with configurable output voltage is shown. The outputs 310 can be freely combined in parallel. The converter is provided, for example, for the assembly of the circuit board, for example, by soldering via the pin-in-paste method. Each phase has a pin output. In the layout of the circuit board, the phases can be connected in parallel. Exemplary output combinations on the 12V side are the following: a) 1×42A; b) 14×3A; c) 1×15A, 2×6A, 5×3 A; d) many other combinations can be realized.

Furthermore, the output voltage levels can be flexibly configured, for example: e) 1×15A (12V), 2×6A (12V), 5×3A at 5V.

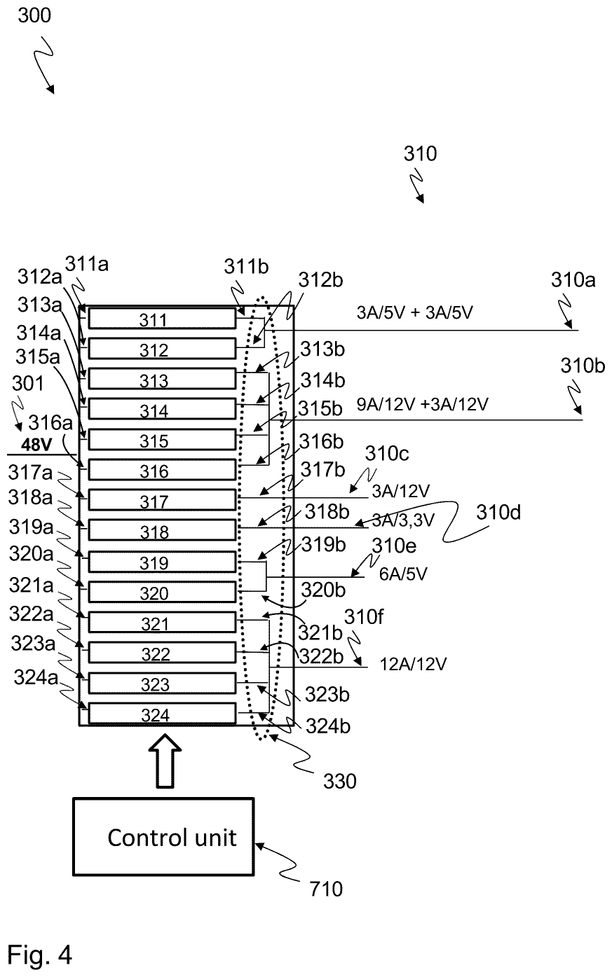

FIG. 4 shows a circuit diagram of a device 300 for the provision of functional voltages in a vehicle electrical system according to another form. The device 300 shown in FIG. 4 corresponds to the multi-phase voltage converter MCD, as described in FIGS. 2 and 3, and constitutes an implementation of the device 300 generally described above for FIG. 3.

In FIG. 4 the configurability of the device 300, which results from the 14 individual phases, is shown in more detail by way of example. In the example of Figure FIG. 4, each phase has 3A continuous load-bearing capacity and 5A peak (peak) load-bearing capacity. The voltage of each phase can be configured by software (SW). The A phases can be freely combined in parallel to outputs by external hardware (HW), which is represented by the connection matrix 330.

As already described above for FIG. 3, the converter can be provided, for example, for the assembly of the circuit board, for example, by soldering in the pin-in-paste method. Each phase has a pin output. In the layout of the circuit board, the phases can be connected in parallel.

Possible output combinations on the 12V side are the following: a) 1×42A 12V; b) 14×3A 5V; c) 1×15A 12V, 2×6A 5V, 5×3 A 3.3V; and d) other combinations can be realized.

The device 300 shown in FIG. 4 serves for the provision of one or more functional voltages in a vehicle electrical system for the supply of electrical components.

The device 300 comprises a device input 325, at which a battery voltage 301 can be applied, and a plurality of device outputs 310a-f, to which the electrical components 133, 134, 135 can be connected.

The device 300 includes a plurality of voltage converters 311-324 with respective inputs 311a-324a, which are connected to the device input 325, and respective outputs 311b-324b.

Each voltage converter 311-324 is configured to provide an output voltage at its output 311b-324b based on a voltage applied to the respective input and an adjustable duty cycle.

The device 300 includes a control unit 710 that is configured to regulate the duty cycle of the respective voltage converters 311-324.

The outputs 311b-324b of the voltage converters 311-324 are connected according to a connection matrix 330 to the device outputs 310a-f to provide a current-carrying capacity of the device outputs 310a-f, which current-carrying capacity is adapted to each connected component 133, 134, 135.

The respective functional voltages are provided at the device outputs 310a-f.

The control unit 710 can be configured to determine a load current for each device output 310a-f, and in the event of an exceeding of a threshold value of the load current to limit the load current to the threshold value.

The connection matrix 330 can be specified by a hardware configuration, or can be configured via software.

Such a hardware configuration can be affected, for example, in the circuit board assembly, for example, by soldering via the pin-in-paste method, as described above. Each phase, i.e., each voltage converter 311-324 has a pin output. In the layout of the circuit board, the phases can be connected in parallel.

The connection matrix 330 can connect each part of the outputs 311b-324b of the voltage converters 311-324 to a respective device output 310a-f, to which a respective functional voltage is provided. All outputs 311b-324b can also be connected to one another, so that only an individual device output 310a-f with very high current-carrying capacity results. Alternatively, the individual outputs 310a-310f of the voltage converters 311-324 can also be led out without any connection between one another, and thus the functional voltages are provided directly at the outputs 310a-310f of the voltage converters 311-324.

A current-carrying capacity of the respective device output 310a-f increases according to the number of outputs 311b-324b of the voltage converters 311-324, and which outputs 311b-324b are connected to the device output 310a-f. For example, by connecting two outputs with 3A, the current-carrying capacity can double to 6A, by connecting of three outputs with 3A, the current-carrying capacity can triple to 9A, etc.

According to the connection matrix 330, a number of N+1 outputs 311b-324b of the voltage converters 311-324 can be connected to a corresponding device output 310a-f to still provide, in the event of a failure of one of the voltage converters 311-324, a current-carrying capacity corresponding to a number of N connected outputs 311b-324b.

The functional voltages and/or the output voltages of the voltage converters 311-324 can be configured for each voltage converter individually or for individual groups of voltage converters 311-324 via software, for example, via the control unit 710 or a different control system.

The disclosure also relates to a method for the provision of one or more functional voltages in a vehicle electrical system for the supply of electrical components.

The method comprises the following steps: connecting the device input 325 of the device 300, as described here in FIG. 4 and the following Figs., to a battery voltage 301; and providing the functional voltages to the device outputs 310a-f of the device 300.

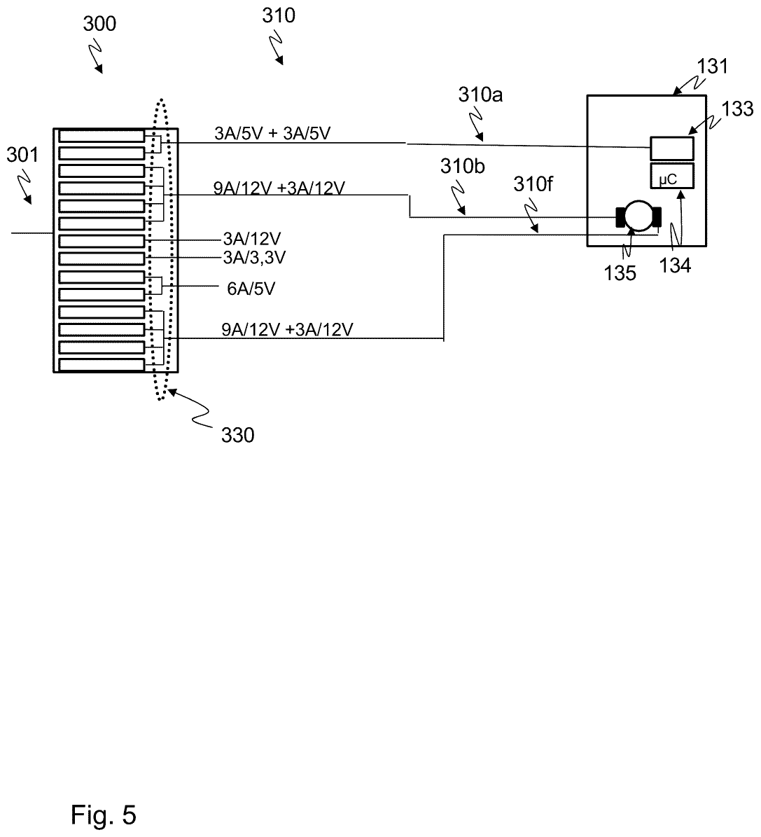

FIG. 5 shows a circuit diagram of a device 300 for the provision of functional voltages in an electrical system with connected electrical components according to a form. The device 300 corresponds to the device 300 already described above for FIG. 4, in which here in FIG. 5 an example circuit with an electric motor 135 is depicted.

The phases or interconnected outputs 310a-310f of the voltage converters 311-324 can also provide 0V, i.e., connection to ground. FIG. 5 shows that when, for example, a DC motor 135 is connected to two phase pairs or two interconnected outputs 310b and 310f, the direction of rotation of the motor 135 can be chosen via the phase control of the MCD 300. If the lower phase is at 0V and the upper at 12V, then a clockwise motion occurs, for example. If the lower phase is at 12V and the upper at 0V, then a counterclockwise motion occurs.

FIG. 5 also shows the FUSI supply “fail operational”. The 9A Motor 135 can be connected to 4 phases for a total of 12A, as shown in FIG. 5. If a phase fails, the 9A Motor 135 can still be supplied safely, since the 9A of the remaining phases are still available.

For the fail operational requirement of the supply of the FUSI consumer, one phase can therefore fail. The provided supply is thus derived from a technical safety concept of the fail silent phases and detection of the failure of a phase. Fail silent means that the phase with the fault can be connected in a high-resistance manner, and thus the parallel phases cannot draw against ground (undervoltage) or, for example, 48V (overvoltage).

As described above, the device 300 can thus be configured to provide a first functional voltage for a first connection 310b of an electric motor 135, and a second functional voltage for a second connection 310f of the electric motor 135.

The device 300 can furthermore be configured, as described above, to provide one of the first and of the second functional voltages as zero volts to set a direction of rotation of the electric motor.

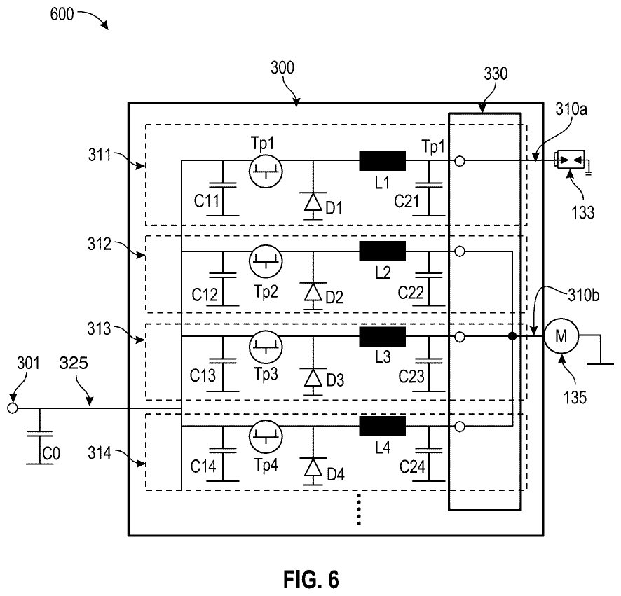

FIG. 6 shows a circuit diagram of a basic circuit of a multiphase converter 600 according to a form. The multiphase converter 600 is a form for the device 300 described above. The control unit 710 is not shown in FIG. 6.

In FIG. 6, by way of example, the first four of the parallel phases of the e-fuse converter 600 are depicted. The input battery voltage 301 can be connected to the 48V backbone. At the 12V output 310a of the first phase, a (small) consumer 133 is connected. The phases 2, 3, and 4 are connected in parallel at the converter outputs, or to one other and to the device output 310b via the connection matrix 330, and provide the 9A channel of a motor load 135. The phases MOSFETs Tp1 to Tp4 each set a PWM (pulse width modulation) with a duty cycle such that the desired output voltage is achieved at the outputs. While FIG. 4 depicts phases MOSFETs Tp1 to Tp4, the converter 600 may have any number of phases MOSFETs Tp1 to Tpn.

Via the duty cycle of the PWM at the series switch Tp1 to Tpn, the current and the resulting voltage at the output can be regulated. For the off-time sections of the clocking of the series switch Tp1 to Tpn, the coil of each phase draws the current via the diodes D (principle of the buck converter).

For balancing of the phases connected in parallel, the regulated voltage (of the 12V outputs) is load-dependent, thus, for example, 12V for a 3A load of the phase up to 13V with less than 0.5A load.

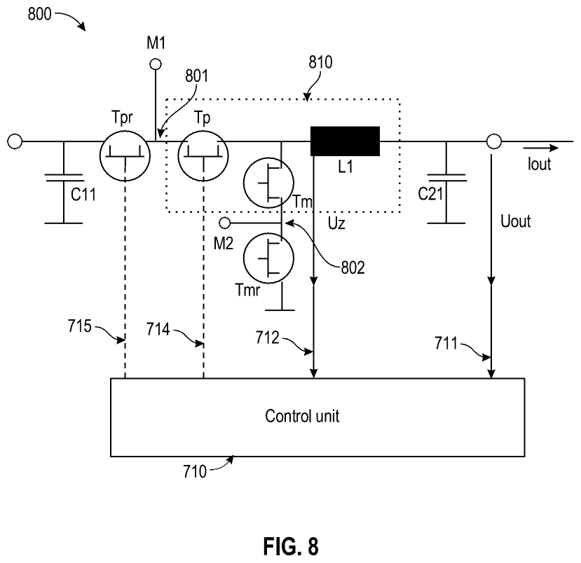

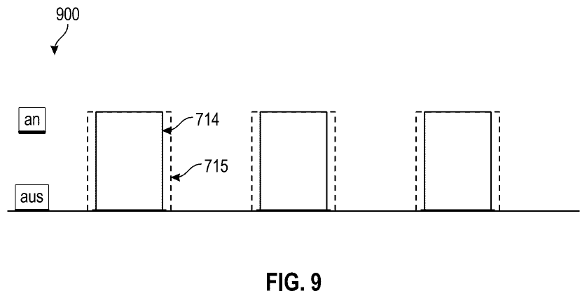

In the base circuit no “fail silent” safety concept for the phases is provided. If a transistor Tp shorts, then the 48V is inevitably connected to the output as overvoltage. An improvement of the base circuit with fail silent safety concept is described in more detail in FIGS. 8 and 9.

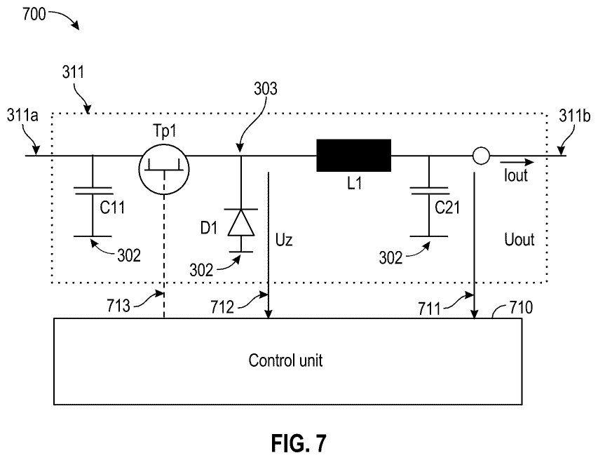

FIG. 7 describes the circuit principle of the circuit in more detail for an individual phase or an individual voltage converter. By way of example, a circuit diagram of an individual phase 700 of the multiphase converter 600 or of an individual voltage converter of the device 300 described above with corresponding control unit 710 is shown, which is provided for each phase.

The respective voltage converters 311-324 described in FIGS. 4 and 5 can be configured as downward converters, and comprise the following:

A first switching element Tp1, for example, a MOSFET, and a coil L1 that are connected in series between the input 311a and the output 311b of the respective voltage converter 311;

A second switching element D1, for example, a diode or also a transistor, which is connected between a node 303, which connects the first switching element Tp1 in series with the coil L1, and a ground connection 302; and

A capacitor C21 that is connected between the output 311b of the respective voltage converter 311-324 and the ground connection 302.

The control unit 710 can be configured to set the duty cycle 713 of the respective voltage converter 311-324 based on the output voltage 711, Uout at the output 311b of the respective voltage converter 311-324 and a voltage 712, Uz at the second switching element D1.

The control unit 710 can be configured to determine an output current Iout of the respective voltage converter 311-324 based on the duty ratio 713, the output voltage 711, Uout and the voltage 712, Uz at the second switching element D1 of the respective voltage converter 311-324.

The control unit 710 can be configured to, in the event of an exceeding of a threshold value of the output current Iout of one of the voltage converters 311-324, control the first switching element Tp1 to carry out an electronic separation of the corresponding voltage converter 311-324 from the battery voltage 301.

With the duty cycle of the PWM, the voltage Uz, and the output voltage Uout, the control unit 710 can adjust Uout and at the same time determine the output current Iout. Another measuring device to measure the current can be omitted. As such, a voltage measuring synchronized with the duty cycle can be implemented. Uz and Uout can be measured with the flanks of the MOSFET “on->off” and “off->on”.

The aforementioned current determination by the control unit 710 facilitates the electronic fusing for each phase. The separation can be affected by the respective PWM-MOSFET Tp1, . . . Tpn. The increase in the short-circuit current of the MOSFET by the inductance of the phase is limited. An additional protective circuit as with normal e-fuses can be omitted.

A transistor stage with two transistors Tv connected in parallel can be connected between the battery voltage 301 and the inputs of the multiphase converter 600 to meet additional safety requirements.

The circuit can thus meet the following FUSI requirements: The e-fuse converter can inhibit, with ASIL D, that the 48V input battery voltage 301 propagates into the 12V electrical system and causes widespread destruction here by overvoltage. The separation of the 48V can be decomposed into an ASIL B(D) switch-off by the upstream MOSFETs Tv, and ASIL B(D) for the separation by the phase transistors Tp1 . . . n. For the Tv stage, a separate measurement of the output voltages of all phases can be implemented.

FIG. 8 shows a circuit diagram of an individual phase 800 of the multiphase converter 600 with control unit for the fail silent design of one of the phases of the multiphase converter according to a form.

The base circuit 810 is located in the framed dashed area. The diode D1 from FIG. 7 is replaced by the actively switching (and to-be-controlled) transistor Tm. For the fail silent function, the transistors Tpr and Tmr are provided that can still separate in the event of failure (shorting) of Tp and Tm. The immediate reaction to low-resistance faults of Tm and Tr is important, since otherwise under- or overvoltage faults occur at the output.

In FIG. 8, a circuit diagram of an individual phase of the multiphase converter 600 or of an individual voltage converter of the device 300 described above with corresponding control unit 710 is shown by way of example, which is provided for each phase.

The circuit 800 is a form for a voltage converter 311-324 of the device 300 described above for FIGS. 4 and 5. The first switching element Tp1 is configured as a series circuit made of a first transistor Tp and a redundant first transistor Tpr; and the second switching element D1 is configured as a series circuit made of a second transistor Tm and a redundant second transistor Tmr.

A first measuring point M1 is formed between a first node 801, which connects the first transistor Tp in series with the redundant first transistor Tpr.

A second measuring point M2 is formed between a second node 802, which connects the second transistor Tm in series with the redundant second transistor Tmr.

The control unit 710 can be configured to detect a functional capacity of the first transistor Tp and of the second transistor Tm, based on a recording of the voltages at the first measuring point M1 and the second measuring point M2.

The first measuring point M1 can, for example, be connected to ground 302 with a pull-down resistance with a parallel capacitor to detect the voltage at the first measuring point M1. The second measuring point M2 can, for example, be connected to ground 302 with a further pull-down resistance with a parallel capacitor to detect the voltage at the second measuring point M2.

With a known functional capacity of the first transistor Tp and of the second transistor Tm, the control unit 710 can be configured to connect the first transistor Tp and the second transistor Tm to power, and to connect the redundant first transistor Tpr and the redundant second transistor Tmr in an unpowered manner, for example, according to a control of the transistors, as described in more detail for FIG. 9.

The control unit 710 can be configured to, in the event of a fault of the first transistor Tp, connect the redundant first transistor Tpr to power, and in the event of a fault of the second transistor Tm, connect the redundant second transistor Tmr to power.

FIG. 9 shows a schematic diagram that shows the control unit 900 of the transistors of the individual phases 800 of the multiphase converter 600 according to one form.

FIG. 9 shows, in dashed lines, the control unit 715 of Tpr, and in solid lines the control unit 714 of Tp. Tp is controlled in a leading manner during switching-on and in a lagging manner during switching-off. The power-connected switching is thus affected via Tp and not via Tpr.

The current commutation is thus affected in the field 810, shown in dashed lines, which must be embodied as small as possible with respect to its surface. The surface is directly proportional to the leakage inductance and capacitance and thus to the EMC disturbance that originates from the phase.

If the switching transistor Tp fails in a low-resistance manner due to a fault, then the pulsed control is affected via the Tpr. The failure of the Tp can be detected on the voltage course at M1. The same mechanism can be implemented for Tm with Tmr and M2.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A device for providing one or more functional voltages in a vehicle electrical system for a supply of electrical components, wherein the device comprises:
a device input at which a battery voltage can be applied, and a plurality of device outputs to which the electrical components can be connected;
a plurality of voltage converters with respective inputs, which are connected to the device input and respective outputs, wherein each voltage converter is configured to provide an output voltage at its output based on a voltage applied to the respective input and an adjustable duty cycle; and
a control unit configured to regulate the duty cycle of the respective voltage converters, wherein the outputs of the voltage converters are connected to the device outputs according to a connection matrix to provide a current-carrying capacity of the device outputs, wherein the current-carrying capacity is adapted for the respective connected component.

2. The device according to claim 1, wherein the control unit is configured to determine a load current for each device output, and in an event of exceeding a threshold value of the load current, to limit the load current to the threshold value.

3. The device according to claim 1, wherein the connection matrix is specified by a hardware configuration, or can be configured via additional switching elements and software.

4. A device according to claim 3, wherein the connection matrix connects each part of the outputs of the voltage converters to a respective device output, at which a respective functional voltage is provided.

5. A device according to claim 4, wherein the current-carrying capacity of the respective device output is increased according to a number of outputs of the voltage converters, and wherein the number of outputs are connected to the device output.

6. A device according to claim 5, wherein according to the connection matrix, a number of N+1 outputs of the voltage converters are connected to a corresponding device output to provide the current-carrying capacity corresponding to a number of N connected outputs in an event of a failure of one of the voltage converters.

7. The device according to claim 1, wherein at least one of the functional voltages and the output voltages of the voltage converters can be configured for each voltage converter individually or for individual groups of voltage converters via software.

8. The device according to claim 1, wherein the respective voltage converters are configured as downward converters, and the respective voltage converters comprise:
a first switching element and a coil, wherein the first switching element and the coil are connected in series between the input and the output of the respective voltage converter;
a second switching element connected between a node that connects the first switching element in series with the coil and a ground connection; and
a capacitor connected between the output of the respective voltage converter and the ground connection.

9. The device according to claim 8, wherein the control unit is configured to set the duty cycle of the respective voltage converters based on the output voltage at the output of the respective voltage converter and a voltage at the second switching element.

10. The device according to claim 9, wherein the control unit is configured to determine, based on the duty cycle, the output voltage and the voltage at the second switching element of the respective voltage converters, and an output current of the respective voltage converters; and
wherein the control unit is configured to control the first switching element to carry out an electronic separation of the corresponding voltage converter from the battery voltage in an event of exceeding a threshold value of the output current of one of the voltage converters.

11. A device according to claim 8,
wherein the first switching element is configured as a series connection made of a first transistor and a redundant first transistor; and
wherein the second switching element is configured as a series connection made of a second transistor and a redundant second transistor.

12. The device according to claim 11,
wherein a first measuring point is configured at a first node which connects the first transistor in series to the redundant first transistor;
wherein a second measuring point is configured at a second node which connects the second transistor in series to the redundant second transistor; and
wherein the control unit is configured to detect a functioning of the first transistor and of the second transistor based on a recording of the voltages at the first measuring point and the second measuring point.

13. The device according to claim 12,
wherein the first measuring point is connected to ground with a pull-down resistance with parallel capacitor; and
wherein the second measuring point is connected to ground with a further pull-down resistance with parallel capacitor.

14. A device according to claim 12, wherein the control unit is configured to, with a known functioning of the first transistor and of the second transistor, connect the first transistor and the second transistor in a powered manner, and to connect the redundant first transistor and the redundant second transistor in an unpowered manner.

15. A device according to claim 12,
wherein the control unit is configured to, in an event of a fault of the first transistor, connect the redundant first transistor in a powered manner, and
wherein the control unit is configured to, in an event of a fault of the second transistor, connect the redundant second transistor in a powered manner.

16. A device according to claim 1, wherein the device is configured to provide a first functional voltage for a first connection of an electric motor, and a second functional voltage for a second connection of the electric motor.

17. The device according to claim 16, wherein the device is configured to provide one of the first functional voltage and the second functional voltage as zero volts to set a direction of rotation of the electric motor.

18. A method for providing one or more functional voltages in a vehicle electrical system for the supply of electrical components, wherein the method comprises:
connecting the device input of the device according claim 1 to a battery voltage; and
providing the functional voltages at the device outputs of the device.
